(19) United States
(12) Patent Application Publication
(10) Pub. No.: US 2017/0179834 A1
(43) Pub. Date: Jun. 22, 2017

(54) POWER CONVERTER AND SWITCH CONTROL MODULE THEREIN

(71) Applicant: RICHTEK TECHNOLOGY CORPORATION, Zhubei City (TW)

(72) Inventor: Tzu-Chen Lin, Tianzhong Township (TW)

(21) Appl. No.: 15/170,897

(22) Filed: Jun. 1, 2016

Related U.S. Application Data
(60) Provisional application No. 62/268,197, filed on Dec. 16, 2015.

(51) Int. Cl. H02M 3/335; H02M 1/08

(52) U.S. Cl. CPC H02M 3/33507; H02M 1/08; H02M 2001/0009

(57) ABSTRACT

A power converter includes: a transformer having a primary side winding to receive a rectified voltage, and a secondary side winding to generate an output DC voltage; a gallium nitride (GaN) M0SFET, coupled to the primary side winding for controlling a primary side current flowing through the primary side winding; a sensing resistor coupled to the GaN transistor switch, for sensing the primary side current to generate a current sensing signal; and a switch control unit, for controlling the GaN transistor switch according to the current sensing signal. The sensing resistor and the GaN transistor switch are connected at a ground node having a voltage level which is the ground of the primary side.

CROSS REFERENCE

The present invention claims priority to U.S. 62/268197, filed on Dec. 16, 2015.

### BACKGROUND OF THE INVENTION

Field of Invention

The present invention relates to a power converter capable of reducing ringing effect, wherein a gallium nitride (GaN) transistor switch, which is a high speed switch, is coupled to a sensing resister through a ground node between the GaN transistor switch and the sensing resister, the ground node having a voltage level which is the ground of a primary side of the power converter, such that a parasitic inductance in the wiring less affects the GaN transistor switch.

Description of Related Art

FIG. 1 shows a prior art power converter 10, which includes: a transformer 11, including a primary side winding 111 to receive a rectified voltage Vo, to generate an output DC (direct current) voltage Vo at a secondary side winding 112; a switch M0, coupled to the primary side winding 111 to control a primary side current Ip through the primary side winding 111; and a switch control unit 12, including a switch control pin Gate, a current sensing pin CS and a ground pin GND. The current sensing pin CS is coupled to the switch M0, and also coupled to a primary side ground Gp through a resistor R and a node N1. The current sensing pin CS is used to sense the current Ip through the primary side winding 111 according to a voltage difference across the resistor R. The switch control unit 12 is coupled to the primary side ground Gp through the ground pin GND and the node N1.

When the switch M0 operates a high speed switch between a conduction status and a nonconduction status, an obvious parasitic inductance will occur in the circuit between the current sensing pin CS and the primary side ground GP, and also in the circuit between the ground pin GND and the primary side ground GP. These parasitic inductances can cause a ringing effect to affect a control signal of the switch M0 (a voltage signal from the switch control pin Gate). This ringing effect can make the switch M0 to be out of control, such that a control of the current Ip correspondingly malfunctions. In this malfunction status, the power conversion is ineffective and the circuit can be damaged.

In view of the demerits caused by the ringing effect by the prior art, the present invention provides a power converter and a switch control module therein, for solving the aforementioned problem caused by the ringing effect.

### SUMMARY OF THE INVENTION

In one perspective, the present invention provides a power converter including:a transformer, including a primary side winding to receive a rectified voltage, and a secondary side winding to generate an output DC (direct current) voltage; a gallium nitride (GaN) transistor switch, coupled to the primary side winding and configured to operably control a primary side current flowing through the primary side winding; a sensing resistor, coupled to the GaN transistor switch and configured to operably generate a current sensing signal by sensing a current flowing through the GaN transistor switch; and a switch control unit, configured to operably control the GaN transistor switch according to the current sensing signal; wherein the sensing resistor and the GaN transistor switch are connected at a ground node between the sensing resistor and the GaN transistor, the ground node having a voltage level which is a ground of the primary side of the power converter.

In one embodiment, the current sensing signal is a negative voltage difference, and the switch control unit includes an inverter and a pulse width modulator, wherein the inverter receives and converts the negative voltage difference to a positive voltage difference, and the pulse width modulator receives the positive voltage difference to generate a control signal for controlling the GaN transistor switch.

In one embodiment, the switch control unit includes a current sensing pin and a ground pin, wherein the ground pin is coupled to the ground of the primary side of the power converter through the ground node, and the sensing resistor is coupled between the ground pin and the current sensing pin.

In one embodiment, the switch control unit further include a setting pin, and the power converter further include a setting resistor, the setting pin being coupled to the ground of the primary side of the power converter through the setting resistor. Preferably, when the current sensing signal is a negative voltage difference, the switch control unit includes: an inverter configured to operably convert the negative voltage difference to a positive voltage difference; a current source configured to operably provide a current to flow through the setting pin, thereby generating a setting voltage; a comparing circuit configured to operably compare the positive voltage difference with the setting voltage; and a pulse width modulator configured to operably generate a control signal for controlling the GaN transistor switch according to an output of the comparing circuit.

In one perspective, the present invention provides a power converter which includes: a transformer, including a primary side winding to receive a rectified voltage, and a secondary side winding to generate an output DC voltage; a gallium nitride (GaN) transistor switch, coupled to the primary side winding and configured to operably control a primary side current flowing through the primary side winding; and a switch control module, configured to operably control the GaN transistor switch, the switch control module including: a sensing resistor, coupled to the GaN transistor switch and configured to operably generate a current sensing signal by sensing a current flowing through the GaN transistor switch; and a switch signal generator, configured to operably control the GaN transistor switch according to the current sensing signal. The sensing resistor and the GaN transistor switch are connected at a ground node between the sensing resistor and the GaN transistor, the ground node having a voltage level which is a ground of the primary side of the power converter.

In one embodiment, wherein the current sensing signal is a negative voltage difference, and the switch signal generator includes an inverter and a pulse width modulator, wherein the inverter receives and converts the negative voltage difference to a positive voltage difference, and the pulse width modulator receives the positive voltage difference to generate a control signal for controlling the GaN transistor switch.

In one embodiment, the aforementioned ground node connected between the sensing resistor and the GaN transistor switch is a ground of the switch control module, wherein the switch control module further includes a current sensing node, and the sensing resistor is coupled between the ground node and the current sensing node.

In one embodiment, the switch control module further includes a current sensing pin configured to couple an external setting resistor to the current sensing node. The external setting resistor is for adjusting the current sensing signal.

In one perspective, the present invention provides a switch control module for use in a power converter which includes a transformer to receive a rectified voltage at a primary side winding and to generate an output DC (direct current) voltage at a secondary side winding, the switch control module comprising: a gallium nitride (GaN) transistor switch, configured to operably control a primary side current flowing through the primary side winding of the transformer; a sensing resistor, coupled to the GaN transistor switch and configured to operably generate a current sensing signal by sensing a current flowing through the GaN transistor switch; and a switch signal generator, configured to operably control the GaN transistor switch according to the current sensing signal; wherein the sensing resistor and the GaN transistor switch are connected at a ground node between the sensing resistor and the GaN transistor, the ground node having a voltage level which is a ground of the primary side of the power converter.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art power converter.

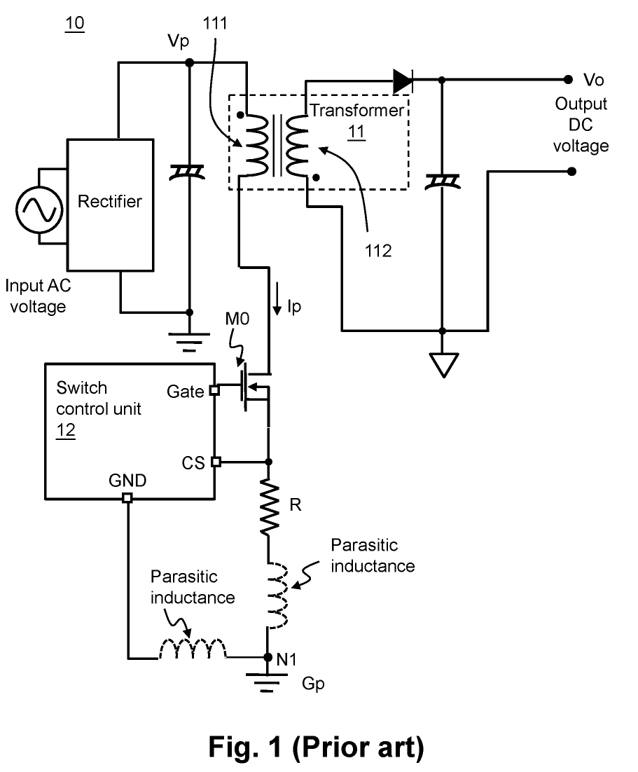

FIG. 2 shows a power converter according to one embodiments of the present invention.

FIGS. 3A and 3B show two switch signal generators according to two embodiments of the present invention, respectively.

FIG. 4 shows a power converter according to another embodiment of the present invention, and a switch control module therein.

FIG. 5 shows a power converter according to yet another embodiment of the present invention, and a switch control module therein.

FIG. 6 shows a power converter according to still another embodiment of the present invention, and a switch control module therein.

### DESCRIPTION OF THE PREFERRED EMBODIMENTS

The drawings as referred to throughout the description of the present invention are for illustrative purpose only, to show the interrelations between the circuits and/or devices, but not drawn according to actual scale.

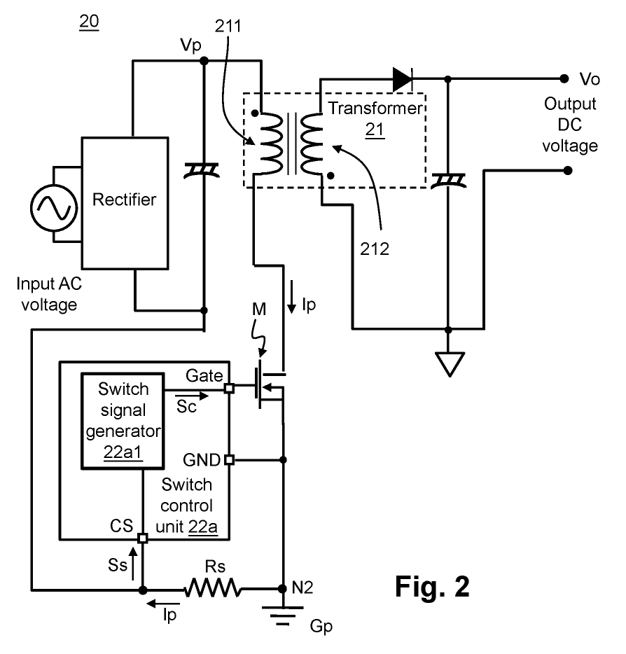

FIG. 2 shows a power converter 20 according to one embodiment of the present invention. The power converter 20 includes: a transformer 21, including a primary side winding 211 to receive a rectified voltage Vp, and a secondary side winding 212 to generate an output DC voltage Vo; a gallium nitride (GaN) transistor switch M, coupled to the primary side winding 221 and configured to operably control a primary side current Ip through the primary side winding 221; a sensing resistor Rs, coupled to the GaN transistor switch M and configured to operably generate a current sensing signal Ss by sensing a current flowing through the GaN transistor switch M (this current is for example the primary side current Ip); and a switch control unit 22a, configured to operably control the GaN transistor switch M according to the current sensing signal Ss. The sensing resistor Rs and the GaN transistor switch M are connected at a ground node N2 between sensing resistor Rs and the GaN transistor switch M, and the ground node N2 has a voltage level which is the primary side ground Gp of the power converter 21. The GaN transistor switch M is capable of switching in a high speed (high frequency), which is higher than a switching speed of a silicon-based transistor switch.

As shown in FIG. 2, the GaN transistor switch M is connected to the sensing resistor Rs through the ground node N2 which corresponds to the primary side ground Gp. The current sensing signal Ss obtained by the sensing resistor Rs is a negative voltage difference in regard to the switch control unit 22a, because the current Ip first passes through the ground node N2, which has a voltage level corresponding to the primary side ground Gp, and next to the sensing resistor Rs. Because the GaN transistor switch M is first connected to the primary side ground Gp and then connected to the sensing resistor Rs, the influence of the parasitic inductance on the current sensing signal Ss is reduced. Therefore, the ringing effect of the prior art power converter is reduced in the power converter of the present invention.

In one embodiment, the power converter 20 can be a flyback power convertor, and the transformer 21 can be an isolated transformer unit.

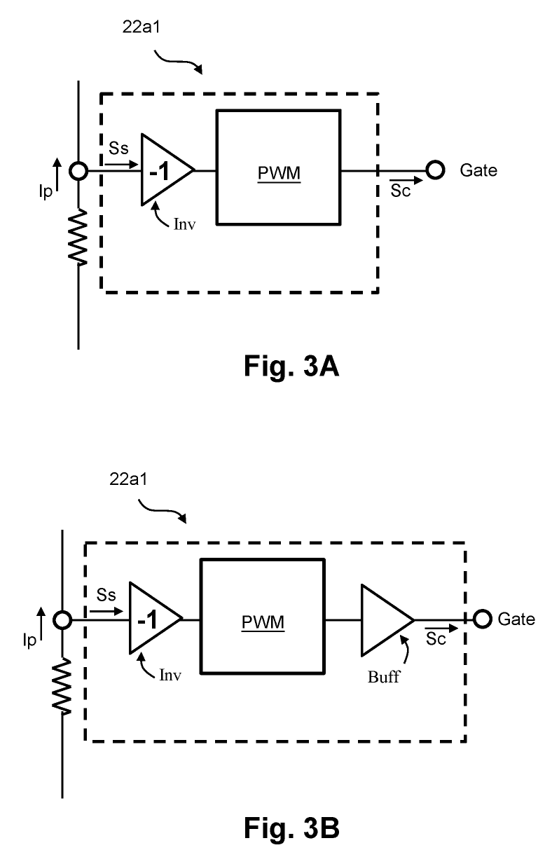

The switch control unit 22a is configured to operably control the GaN transistor switch M according to the current sensing signal Ss. In one embodiment as shown in FIG. 2, the switch control unit 22a includes a switch signal generator 22a1 which is configured to generate the control signal Sc for controlling the GaN transistor switch M. FIG. 3A shows one embodiment of the switch signal generator 22a1, which includes an inverter Inv and a pulse width modulator PWM. The inverter Inv receives and converts the negative voltage difference generated by the sensing resistor Rs with reference to the primary side ground Gp, to generate a positive voltage difference. The pulse width modulator PWM generates a control signal Sc according to the positive voltage difference, which corresponds to the sensing result of the current Ip, for controlling an operation of the GaN transistor switch M.

FIG. 3B shows another switch signal generator according to one embodiment of the present invention. In comparison with FIG. 3A, the switch signal generator 22a1 in FIG. 3B further includes an amplifier circuit Buff. In case that the voltage level of the output signal of the pulse width modulator PWM needs to be adjusted to a level sufficient to drive the GaN transistor switch M, the amplifier circuit Buff can be included in the switch signal generator 22a1 for such voltage level adjustment.

In one embodiment, the switch control unit 22a (shown in FIG. 2) includes a current sensing pin CS and a ground pin GND, and a switch control pin Gate. The ground pin GND is coupled to the primary side ground Gp of the power converter 21 through the ground node N2. The sensing resistor Rs is coupled between the ground pin GND and the current sensing pin CS. The sensing resistor Rs can also be regarded as coupled between the ground node N2 and the current sensing pin CS. The switch control pin Gate is coupled to the GaN transistor switch M, for providing the control signal Sc to a gate of the GaN transistor switch M.

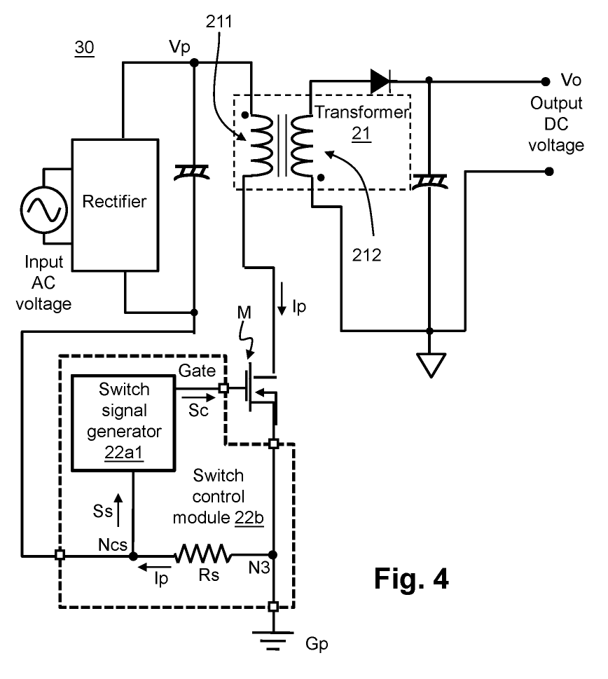

FIG. 4 shows a power converter 30 according to another embodiment of the present invention, for generating an output DC voltage Vo according to a rectified voltage Vp. The power converter 30 includes: a transformer 21, including a primary side winding 211 to receive the rectified voltage Vp, and a secondary side winding 212 to generate the output DC voltage Vo; a GaN transistor switch M, coupled to the primary side winding 211 and configured to operably control a primary side current Ip flowing through the primary side winding 211; and a switch control module 22b, configured to operably control the GaN transistor switch M. In one embodiment shown in FIG. 4, the switch control module 22b includes: a sensing resistor Rs, coupled to the GaN transistor switch M and configured to operably generate a current sensing signal Ss by sensing a current Ip through the GaN transistor switch M; and a switch signal generator 22a1, configured to operably control the GaN transistor switch M according to the current sensing signal Ss. The sensing resistor Rs and the GaN transistor switch M are connected at a ground node N3, which has a voltage level which is a primary side ground Gp of the power converter 30.

The embodiment of FIG. 4 is different from the aforementioned embodiment of FIG. 2 in that the switch signal generator 22a1 and the sensing resistor Rs are integrated in the switch control module 22b, which is packaged as an integrated module.

In one embodiment, the switch control unit 22b further includes a current sensing node Ncs and the ground node N3. The ground node N3 is coupled to the primary side ground Gp of the power converter. The sensing resistor Rs is coupled between the ground node N3 and the current sensing node Ncs. The switch control module 22b senses the negative voltage difference generated by the sensing resistor Rs with reference to the primary side ground Gp; and this negative voltage difference is the current sensing signal Ss. The switch control unit 22b generates a control signal Sc according to the current sensing signal Ss, for controlling the GaN transistor switch M. The control signal Sc is generated as described in the embodiments of FIGS. 3A and 3B, which is not redundantly repeated here.

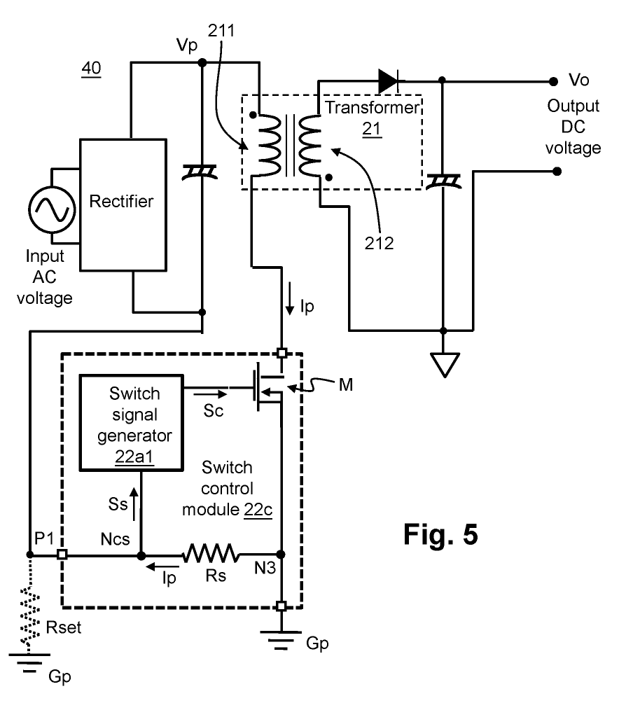

FIG. 5 shows a power converter 40 according to another embodiment of the present invention, for generating an output DC voltage Vo according to a rectified voltage Vp. Similar to the power converter 30, the power converter 40 includes: a transformer 21, a GaN transistor switch M, and a switch control module 22c. The difference between this embodiment and the previous embodiment is that: the switch control module 22c of the power converter 40 integrates the GaN transistor switch M inside the module, while the switch control module 22b of the power converter 30 does not include the GaN transistor switch M.

In the embodiments of FIGS. 4 and 5, by integrating the components into a packaged module, the length of the wiring of the control loop for the GaN transistor switch M can be shortened to reduce the influence of the parasitic inductance. If the GaN transistor switch and the switch control unit are respectively in different packages and mounted on a printed circuit board (PCB), at least a portion of the wiring of the control loop is formed on the PCB, which means that the length of the wiring of the control loop on the PCB is inevitably longer than the length of the wiring in the integrated module package. The longer length of the wiring on the PCB produces a worse parasitic inductance effect.

Referring to FIG. 5, because the switch control module 22c is manufactured as an integrated module package which includes the sensing resistor Rs as an internal component, a user cannot adjust the current sensing signal Ss (for example but not limited to adjusting a ratio between the current sensing signal Ss and the current Ip flowing through the GaN transistor switch M. According to the present invention) by changing a different sensing resistor Rs having a different resistance. According to the present invention, a pin P1 connected at the current sensing node Ncs can be provided in the switch control module 22c, and the pin P1 is coupled to the primary side ground Gp through a setting resistor Rset. The setting resistor Rset and the sensing resistor Rs form a parallel circuit, such that the ratio between the current sensing signal Ss and the current Ip can be adjusted by setting different reset resistors Rset of different resistances. To provide a pin P1 for connecting setting resistor Rset is an option, which can be also embodied in the embodiment of FIG. 4. However, this arrangement is only an option.

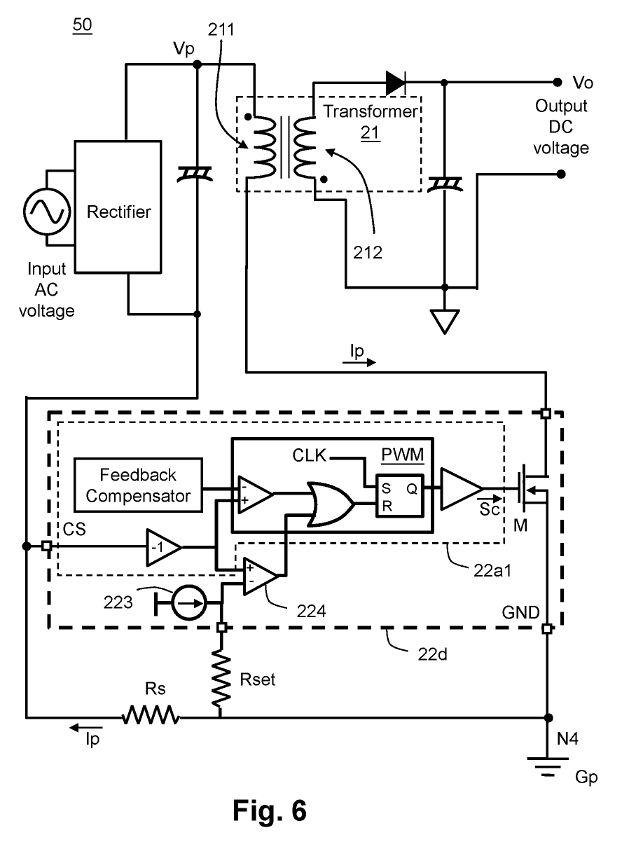

Referring to FIG. 6, for certain reasons (for example but not limited to: it is desired to fix the loop compensation parameters or internal parameters in the switch control module 22d), the switch control module 22d does not include the sensing resistor Rs as an internal component, and the user cannot or does not desire to change the resistance of the sensing resistor Rs, but the user desires to make a certain adjustment on the current sensing signal Ss when this signal is retrieved by the switch control module 22d, then, according to this embodiment of the present invention, a setting resistor Rset can be connected in the way as shown, to a setting pin SET. In the switch control module 22d, a current source 223 sends a current outward through the setting resistor Rset to generate a voltage drop across the setting resistor Rset, and a comparing circuit 224 (which can be a digital comparator or an analog operational amplifier) compares or operates the voltage drop with the current sensing signal Ss to adjust the value of the current sensing signal Ss when the current sensing signal Ss is processed by the following circuit. Thus, by setting a different resistance to the setting resistor Rset, the current sensing signal Ss is adjustable.

This embodiment also shows an example of the pulse width modulator PWM. It should be noted that what is shown in FIG. 6 is only an illustrative example; the pulse width modulator PWM can be embodied in many possible forms. What is shown in FIG. 6 is a fixed-frequency form wherein the current peak determines a duty of the power switch. In other embodiments, it can be a variable-frequency form with a constant ON time or OFF time, or, the frequency and duty can be determined by other ways. The present invention is not limited to any of the above forms.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention; for example, there may be additional devices or circuits inserted between two devices or circuits shown to be in direct connection in the embodiments, as long as such inserted devices or circuits do not affect the primary function of the circuitry. Besides, an embodiment or a claim of the present invention does not need to attain or include all the objectives, advantages or features described in the above. The abstract and the title are provided for assisting searches and not to be read as limitations to the scope of the present invention. It is not limited for each of the embodiments described hereinbefore to be used alone; under the spirit of the present invention, two or more of the embodiments described hereinbefore can be used in combination. For example, two or more of the embodiments can be used together, or, apart of one embodiment can be used to replace a corresponding part of another embodiment.

What is claimed is:

1. A power converter, comprising:
a transformer, including a primary side winding to receive a rectified voltage, and a secondary side winding to generate an output DC (direct current) voltage;
a gallium nitride (GaN) transistor switch, coupled to the primary side winding and configured to operably control a primary side current flowing through the primary side winding;
a sensing resistor, coupled to the GaN transistor switch and configured to operably generate a current sensing signal by sensing a current flowing through the GaN transistor switch; and
a switch control unit, configured to operably control the GaN transistor switch according to the current sensing signal;
wherein the sensing resistor and the GaN transistor switch are connected at a ground node between the sensing resistor and the GaN transistor, the ground node having a voltage level which is a ground of the primary side of the power converter.

2. The power converter of claim 1, wherein the current sensing signal is a negative voltage difference, and the switch control unit includes an inverter and a pulse width modulator, wherein the inverter receives and converts the negative voltage difference to a positive voltage difference, and the pulse width modulator receives the positive voltage difference to generate a control signal for controlling the GaN transistor switch.

3. The power converter of claim 1, wherein the switch control unit includes a current sensing pin and a ground pin, wherein the ground pin is coupled to the ground of the primary side of the power converter through the ground node, and the sensing resistor is coupled between the ground pin and the current sensing pin.

4. The power converter of claim 3, wherein the switch control unit further include a setting pin, and the power converter further include a setting resistor, the setting pin being coupled to the ground of the primary side of the power converter through the setting resistor.

5. The power converter of claim 4, wherein the current sensing signal is a negative voltage difference, and wherein the switch control unit includes:
an inverter configured to operably convert the negative voltage difference to a positive voltage difference;
a current source configured to operably provide a current to flow through the setting pin, thereby generating a setting voltage;
a comparing circuit configured to operably compare the positive voltage difference with the setting voltage; and
a pulse width modulator configured to operably generate a control signal for controlling the GaN transistor switch according to an output of the comparing circuit.

6. A power converter, comprising:
a transformer, including a primary side winding to receive a rectified voltage, and a secondary side winding to generate an output DC voltage;
a gallium nitride (GaN) transistor switch, coupled to the primary side winding and configured to operably control a primary side current flowing through the primary side winding;
and a switch control module, configured to operably control the GaN transistor switch, the switch control module including:
a sensing resistor, coupled to the GaN transistor switch and configured to operably generate a current sensing signal by sensing a current flowing through the GaN transistor switch; and
a switch signal generator, configured to operably control the GaN transistor switch according to the current sensing signal;
wherein the sensing resistor and the GaN transistor switch are connected at a ground node between the sensing resistor and the GaN transistor, the ground node having a voltage level which is a ground of the primary side of the power converter.

7. The power converter of claim 6, wherein the current sensing signal is a negative voltage difference, and the switch signal generator includes an inverter and a pulse width modulator, wherein the inverter receives and converts the negative voltage difference to a positive voltage difference, and the pulse width modulator receives the positive voltage difference to generate a control signal for controlling the GaN transistor switch.

8. The power converter of claim 6, wherein the ground node is connected to a ground of the switch control module, wherein the switch control module further includes a current sensing node, and the sensing resistor is coupled between the ground node and the current sensing node.

9. The power converter of claim 8, wherein the switch control module further includes a current sensing pin configured to couple an external setting resistor to the current sensing node, wherein the external setting resistor is for adjusting the current sensing signal.

10. A switch control module for use in a power converter which includes a transformer to receive a rectified voltage at a primary side winding and to generate an output DC (direct current) voltage at a secondary side winding, the switch control module comprising:
a gallium nitride (GaN) transistor switch, configured to operably control a primary side current flowing through the primary side winding of the transformer;
a sensing resistor, coupled to the GaN transistor switch and configured to operably generate a current sensing signal by sensing a current flowing through the GaN transistor switch; and
a switch signal generator, configured to operably control the GaN transistor switch according to the current sensing signal;
wherein the sensing resistor and the GaN transistor switch are connected at a ground node between the sensing resistor and the GaN transistor, the ground node having a voltage level which is a ground of the primary side of the power converter.

11. The switch control module of claim 10, wherein the current sensing signal is a negative voltage difference, and the switch signal generator includes an inverter and a pulse width modulator, wherein the inverter receives and converts the negative voltage difference to a positive voltage difference, and the pulse width modulator receives the positive voltage difference to generate a control signal for controlling the GaN transistor switch.

12. The switch control module of claim 10, wherein the ground node is connected to a ground of the switch control module, wherein the switch control module further includes a current sensing node, and the sensing resistor is coupled between the ground node and the current sensing node.

13. The switch control module of claim 12, further comprising a current sensing pin configured to couple an external setting resistor to the current sensing node, wherein the external setting resistor is for adjusting the current sensing signal.
